(19) United States
(12) Patent Application Publication
(10) Pub. No.: US 2003/0081726 A1
(43) Pub. Date: May 1, 2003

(54) Vacuum tube

(76) Inventor: Lothar Koch, Hamburg (DE)

Correspondence Address: EUGENE E. CLAIR, Philips Medical Systems (Cleveland), Inc., 595 Miner Road, Cleveland, OH, 44095, US

(21) Appl. No.: 10/279,418

(22) Filed: Oct. 24, 2002

(30) Foreign Application Priority Data
Oct. 31, 2001 (DE) 10153779.4

(51) Int. Cl. H05H 1/00

(52) U.S. Cl. 378/119

(57) ABSTRACT

The invention relates to a vacuum tube (1) for the processing or conversion of electric powers, for example, an X-ray tube or a traveling-wave tube, which tube includes at least one surface which is to be cooled by thermal emission in the operating condition, as well as a getter which serves to avoid an undesirable pressure increase. The tube is notably characterized in that the getter is provided in the form of a coating (30) partly or completely on the surface of the tube (1) to be cooled, the coating having a thickness such that it has a thermal emissive power which is adequate for the cooling.

### BACKGROUND

The invention relates to a vacuum tube for the processing or conversion of electric powers, for example, an X-ray tube or a traveling-wave tube, which tube includes at least one surface which is to be cooled by thermal emission during operation as well as a getter which serves to avoid an undesirable pressure increase.

The following two factors are of special importance in preserving the operating properties and the reliability of such vacuum tubes over an as long as possible service life.

Because of physically unavoidable losses, the conversion of electric powers into electromagnetic radiation is accompanied by the development of large quantities of heat at different parts or surfaces inside the tube. These quantities of heat must be removed, possibly after temporary storage in a material having a high thermal capacity, by way of a means for the removal of heat. In many cases, for example, in rotary anode X-ray tubes, such a means is formed mainly or substantially by a surface emitting the heat.

In order to enable a given quantity of heat to be emitted at an as low as possible temperature, an as high as possible specific emission coefficient is required for the surface emitting or absorbing the heat.

High temperatures are undesirable, because they may cause damage to the tube or limit the permissible operating parameters directly under the influence of temperature or by the emission of gas by the materials and the accompanying pressure increase in the tube. The formation of surfaces having an adequate thermal emissive power requires intricate and expensive operations such as, for example, electroplating or reactive sputtering of the relevant surfaces as described, for example, in JP-07134958A.

In order to preserve the vacuum with a pressure which is sufficiently low for reliable operation of the tube, moreover, generally gas-absorbing materials (getters) have to be introduced into the tube. For example, WO 99/05697 discloses a miniaturized X-ray source for introduction into the body of a patient; this source includes a cold cathode made of getter material. The getter serves as a degasifying substance for binding gas molecules which escape from the anode material and from other sources in the course of time and are capable of contaminating the vacuum. Getter materials may contain zirconium, aluminum, vanadium, iron and/or titanium and be formed, for example, as an alloy of vanadium, iron and zirconium.

A problem encountered in conjunction with the use of getter consists in that the getter must first be introduced into the tube in inactive form, because otherwise it would react with the ambient atmosphere and hence would become unusable, and in that the getter may be activated by heating only after an adequate vacuum has been formed.

For activation such getters must typically be heated to a temperature of from 800° C. to 900° C. for a few minutes. During the activation the atoms bound on the surface of the getter (mainly carbon, oxygen and nitrogen) are diffused in the interior of the material and leave a metal surface which is capable of absorbing gases. The degree of activation is a function of time and temperature and an adequate activation can be achieved also by using significantly lower temperatures and correspondingly prolonged periods of time.

The getter in high-performance vacuum tubes is generally situated in a getter pot which is connected to the evacuated interior of the tube; such a getter can be activated by heating by means of a resistance heating wire.

This has the drawback that additional components and at least one passage through the tube wall into the vacuum are required for the getter pot. Moreover, an electrical lead for applying the electric current to the heating wire must be passed through the wall of the getter pot from the outside.

The foregoing on the one hand requires comparatively intricate manufacturing steps which lead to extra costs. Moreover, every passage of this kind involves the risk of leakage which may give rise to a total failure of the tube. Finally, because of its small volume, the absorption capacity of the getter is also comparatively small, so that ultimately the maximum service life of the tube is again limited.

Overall the realization of adequate removal of heat while avoiding a pressure increase in the vacuum has a significant cost effect and at the same time a decisive impact on the operating properties, the reliability and the service life of vacuum tubes.

### SUMMARY OF THE INVENTION

Therefore, it is an object of the present invention to provide a vacuum tube of the kind set forth which can be manufactured substantially more economically, without having to accept drawbacks in respect of the operating properties, the reliability and the service life of the tube.

It is also an object of the invention to provide a vacuum tube of the kind set forth in which the activation of the getter can be carried out comparatively simply and without having to use special additional accessories.

It is a further object of the invention to provide a vacuum tube of the kind set forth in which the activation of the getter can be carried out at practically any instant during or after the manufacture of the tube.

It is another object of the invention to provide a vacuum tube of the kind set forth in which the efficiency and capacity of the getter are significantly enhanced.

The object is achieved by means of a vacuum tube of the kind set forth as disclosed in claim 1 by providing the getter in the form of a coating completely or partly on the surface of the tube to be cooled, the coating having a thickness such that it has an adequate thermal emissive power for the cooling.

Since such a coating thus serves as the getter as well as for the removal of heat, more than only a simplified construction and savings are achieved in the manufacture of the tube. It is now notably possible to realize also a getter structure which has a large surface area and a correspondingly high absorptivity, resulting in a significant prolongation of the service life or the service intervals.

The dependent claims relate to advantageous further embodiments of the invention.

One embodiment of an apparatus in accordance with principles of the present invention offers the advantage that the activation of the getter does not necessitate the use of separate heating devices and electrical leads which would have to be passed through a wall of the tube for the supply of an electrical heating current.

A further advantage of this solution consists in that, if necessary, the getter can be reactivated also during later operation, for example, in the context of maintenance. Such reactivation can be controlled from a remote location. It is not necessary to modify the system architecture and the service life of the tube can be prolonged by means of a getter which is permanently kept in a state of optimal effectiveness.

Another embodiment in conformity with principles of the present invention offers the advantage that the activation can take place at a desired instant during the manufacture of the tube. This enables an optimum manufacturing process in respect of time and costs.

Yet another embodiment according to principles of the present invention enables these advantages to be achieved also when a higher activation temperature and a longer activation time are required on given surfaces.

Additional advantages are further disclosed regarding particularly advantageous material compositions for the coating.

The following description, claims and accompanying drawings set forth certain illustrative embodiments applying various principles of the present invention. It is to be appreciated that different embodiments applying principles of the invention may take form in various components, steps and arrangements of components and steps. These described embodiments being indicative of but a few of the various ways in which some or all of the principles of the invention may be employed in a method or apparatus. The drawings are only for the purpose of illustrating an embodiment of an apparatus and method applying principles of the present invention and are not to be construed as limiting the present invention.

### BRIEF DESCRIPTION OF THE DRAWINGS

The foregoing and other features and advantages of the present invention will become apparent to those skilled in the art to which the present invention relates upon consideration of the following detailed description of apparatus applying aspects of the present invention with reference to the accompanying drawings, wherein:

FIG. 1 is a diagrammatic longitudinal sectional view of an X-ray tube in accordance with the invention, and

FIG. 2 is a diagrammatic longitudinal sectional view of a part of the tube shown in FIG. 1.

### DETAILED DESCRIPTION

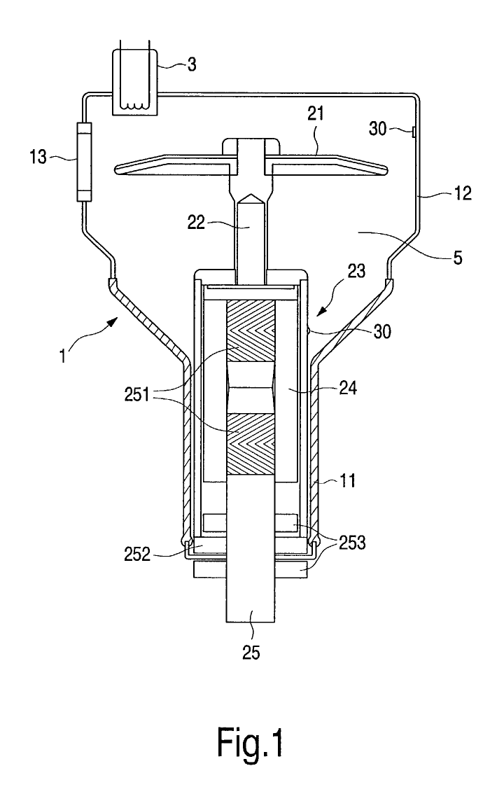

FIG. 1 is a longitudinal sectional view of the essential parts of a rotary-anode X-ray tube 1. A vacuum space 5 is enclosed by an essentially cylindrical glass envelope 11 which is widened at one end, as well as by an adjoining metal housing 12. The vacuum space 5 accommodates an anode disc 21 which is supported by an anode shaft 22. The anode shaft 22 is attached to a rotor 23 which is journaled, by way of a bearing sleeve 24, so as to be rotatable on a bearing element 25 which is provided with spiral groove bearings 251. The bearing element 25 serves to hold the X-ray tube 1 whereas the bearing sleeve 24 represents the rotor of a motor which is arranged outside the X-ray tube, that is, at the area of the glass envelope 11, and rotates the anode disc 21. In order to journal the rotor 23 in the axial direction, its lower end (in the Figure) is provided with a first ring magnet 252 which is retained between two second ring magnets 253 which are connected to the bearing element 25.

At the front of the metal housing 12 there is provided a cathode 3 with a filament wherefrom an electron beam is directed onto the inclined, radial outer zone of the anode disc 21, thus exciting X-rays which emanate from the X-ray tube via an exit window 13 provided in the metal housing 12.

During the operation of the X-ray tube, a large amount of loss heat is produced on the anode disc 21, notably in the radial outer zone thereof in which the X-rays are excited. This heat on the one hand is thermally radiated by the anode disc 21 but on the other hand also propagates to a considerable extent, via the anode shaft 22, to the rotor 23 where it is also radiated. Even when the rotor 23 is connected to the bearing sleeve 24 only by way of its upper front side (as viewed in the drawing), the bearing sleeve 24 and the bearing element 25 will also be heated via this connection. An excessive temperature increase of notably these parts, however, is undesirable because it may give rise to increased bearing wear and possibly bearing damage.

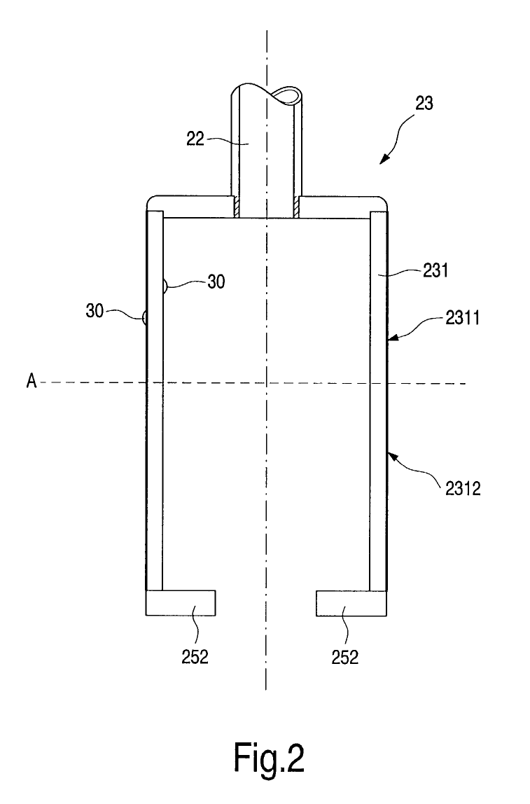

FIG. 2 is a diagrammatic representation at an increased scale of the rotor 23 with the first ring magnet 252 and a part of the anode shaft 22. The heat propagating via the anode shaft 22 has a particularly strong heating effect on the upper part 2311 (as viewed in the drawing) of the rotor 23 which extends approximately as far as the dashed line A, whereas the lower part 2312 generally has a distinctly lower temperature already because of the heat radiated by the whole surface 231 of the rotor. The upper part 2311 may reach, for example, temperatures of up to 500° C. for a few minutes during normal operation, whereas the lower part 2312 has dropped to temperatures of approximately 300° C.

As has already been described, for reliable and lasting operation of a vacuum tube it is necessary that on the one hand, notably in the case of tubes comprising moving parts, adequate removal of heat is ensured and that on the other hand the vacuum is maintained with a suitably low pressure without contamination by gases from materials.

This problem is solved by providing a coating 30 in the inner space 5 of the tube, which coating has the function of a getter and also has an increased thermal emissive power.

For example, the surfaces in the tube which are blackened in known tubes, or are to be cooled by thermal emission, are provided with the coating. In the case of the X-ray tube shown in FIG. 1, notably the outer side and the inner side of the rotor jacket 231 and the inner wall of the metal housing 12 are provided with the coating 30. Furthermore, the coating may also be provided on at least a part of the cathode 3.

In order to realize a further improvement of the specific heat radiation and the getter effect, the surfaces to be coated can be enlarged by first milling or turning ridges or recesses in said surfaces or by roughing the surfaces by blasting before application of the coating.

The coating 30 contains at least two materials of the group formed by titanium, zirconium and vanadium. The choice and the proportion of the constituent materials are chosen to be such that for a tube with the above-mentioned temperature ranges there are obtained a getter activation temperature of approximately 400° C. and a getter activation time of between approximately 0.2 and one hour.

The temperature required for the activation can then be produced for the necessary period of time either during the manufacture of the tube (for example, in steps) or at one or more optimum or suitable instants by application of external heat. On the other hand, it is also possible to perform the activation (completely or partly) by appropriate putting into operation or in a single normal operating phase or a number of normal operating phases of the tube. This can also take place after the manufacture of the tube, that is, at the customer's site, by way of an appropriate first putting into operation. When in that case coated parts do not reach the necessary activation temperature, or not for a sufficiently long period of time, during normal operation, the coating can be activated by one or more controlled, brief overload operating phases of the tube or by additional external application of heat. In no case, however, will separate passages through the wall of the tube be required, so that said risk of leakage is avoided.

Suitable material combinations for the coating with an activation temperature of approximately 400° C. and an activation time of between approximately 0.2 and one hour are, for example, approximately from 20 to 50% vanadium and from 80 to 50% titanium; also feasible is a composition of approximately from 10 to 30% vanadium and from 90 to 70% zirconium, and also a combination of from approximately 20 to 80% zirconium and from 80 to 20% titanium. Furthermore, a combination of approximately from 70 to 90% zirconium as well as from 30 to 10% titanium and vanadium has also proved to be suitable, the titanium component amounting to approximately from 5 to 95% relative to the vanadium component.

Finally, a combination of from approximately 60 to 90% titanium as well as from 40 to 10% zirconium and vanadium is also suitable, the zirconium component then amounting to from approximately 5 to 95% relative to the vanadium component.

The coating can be deposited by sputtering, in which case use can be made of either a corresponding mixture of the basic materials or of three single sputter targets with the relevant basic materials. However, other, generally known coating methods can also be used, for example, plasma spraying or vapor deposition.

The thickness of the coating determines, in addition to the getter capacity, also the specific heat radiation (degree of blackening) that can be achieved. Therefore, in the case of a coated surface area of at least approximately 100 square cm, it should amount to at least 1 μm; however, it should preferably be distinctly greater than the wavelength maximum at the desired operating temperature (approximately 3.5 μm at 550° C. and approximately 6 μm at 200° C.) of the coated part. Depending on the operating temperature, the preferred coating thickness thus amounts to from approximately 1 to approximately 20 μm, but preferably from approximately 5 to approximately 20 μm.

Such a coating could then be activated in steps, depending on the progress, in the course of the manufacturing process, that is, also automatically, so that a suitable (low) tube pressure is always ensured during the high voltage conditioning. Coatings having different material compositions with different activation temperatures may also be used for this purpose.

In a further embodiment of the invention the rotor jacket 231 is provided with a coating which consists of a combination of the materials titanium, zirconium and vanadium and has an activation time of from 0.2 to one hour at a temperature beyond 600° C. Such a coating can be activated in a controlled manner by raising the temperature of the rotor 23, for example, by punctual heating from the outside, to a value which is higher than the normal operating temperature. Also suitable are various other methods which can be readily carried out, for example, heating by induction heating (notably in the case of glass tubes) as well as the chaining of a plurality of starting/deceleration operations while utilizing the losses due to eddy currents, or a combination of these methods and the normal heating during the operation or a brief overload operation of the tube. At the same time other parts, for example, the housing, can be cooled in a controlled manner.

In this embodiment it is also possible to carry out the activation or reactivation of the getter layer at the customer's site, that is, for example by choosing a special mode of operation of the tube or by way of an automatic or remote-controlled maintenance process for restoring the vacuum quality after prolonged operation of the tube.

The optimum operating temperature, and hence the composition of the coating, should be adapted to the permissible operating temperatures of the relevant component and the manufacturing process.

The invention is of course not limited to the described or shown embodiments, but generally extends to any embodiment, which falls within the scope of the appended claims as seen in light of the foregoing description and drawings. While a particular feature of the invention may have been described above with respect to only one of the illustrated embodiments, such features may be combined with one or more other features of other embodiments, as may be desired and advantageous for any given particular application. From the above description of the invention, those skilled in the art will perceive improvements, changes and modification. Such improvements, changes and modification within the skill of the art are intended to be covered by the appended claims.

Having described a preferred embodiment of the invention, the following is claimed:

1. A vacuum tube for the processing or conversion of electric powers, which tube includes at least one surface which is to be cooled by thermal emission during operation as well as a getter which serves to avoid an undesirable pressure increase, the getter being provided in the form of a coating (30) completely or partly on the surface of the tube (1) to be cooled, the coating having a thickness such that it has an adequate thermal emissive power for the cooling.

2. A vacuum tube as claimed in claim 1, characterized in that the material for the coating (30) is chosen to be such that the activation temperature and the activation time of the getter can be achieved by way of one or more phases of normal operation or by way of one or more brief phases of overload operation of the vacuum tube.

3. A vacuum tube as claimed in claim 1, characterized in that the material for the coating (30) is chosen in such a manner that the activation temperature and the activation time of the getter can be achieved by way of temperatures occurring during the manufacture of the vacuum tube.

4. A vacuum tube as claimed in claim 2, characterized in that the activation temperature and the activation time of the getter can be realized by way of additional, external application of heat.

5. A vacuum tube as claimed in claim 1, characterized in that the coating (30) consists of at least two of the three materials vanadium, zirconium, titanium.

6. A vacuum tube as claimed in claim 5, characterized in that the coating (30) contains approximately from 20 to 50% vanadium and from 80 to 50% titanium.

7. A vacuum tube as claimed in claim 5, characterized in that the coating (30) contains approximately from 10 to 30% vanadium and from 90 to 70% zirconium.

8. A vacuum tube as claimed in claim 5, characterized in that the coating (30) contains approximately from 20 to 80% zirconium and from 80 to 20% titanium.

9. A vacuum tube as claimed in claim 5, characterized in that the coating (30) contains approximately from 70 to 90% zirconium as well as from 30 to 10% titanium and vanadium, the titanium component amounting to approximately from 5 to 95% relative to the vanadium component.

10. A vacuum tube as claimed in claim 5, characterized in that the coating (30) contains approximately from 60 to 90% titanium as well as from 40 to 10% zirconium and vanadium, the zirconium component amounting to approximately from 5 to 95% relative to the vanadium component.

11. A vacuum tube as claimed in claim 3, characterized in that the activation temperature and the activation time of the getter can be realized by way of additional, external application of heat.

12. An X-ray tube comprising:
at least one surface cooled by thermal emission during operation; and
a getter to avoid an undesirable pressure increase, the getter provided in the form of a coating on the surface to be cooled by thermal emission, the coating having a thickness such that it has an adequate thermal emissive power for the cooling.

13. The X-ray tube of claim 12, wherein the material for the getter has an activation temperature and an activation time, the activation time and activation temperature achieved by at least one of a phase of normal operation and a phase of overload operation of the x-ray tube.

14. The X-ray tube of claim 12, wherein the material for the getter has an activation temperature and an activation time, the activation time and activation temperature of the getter achieved during the manufacture of the X-ray tube.

15. The X-ray tube of claim 13, wherein the activation temperature and the activation time of the getter can be realized by way of additional, external application of heat.

16. The X-ray tube of 12, wherein the getter comprises at least two of vanadium, zirconium, titanium.

17. The X-ray tube of claim 16, wherein the getter comprises approximately 20% to 50% vanadium and 80% to 50% titanium.

18. The X-ray tube of claim 16, wherein the getter comprises approximately 10% to 30% vanadium and 90% to 70% zirconium.

19. The X-ray tube of claim 16, wherein the getter comprises approximately 20% to 80% zirconium and 80% to 20% titanium.

20. The X-ray tube of claim 16, wherein the getter comprises approximately 70% to 90% zirconium as well as 30% to 10% titanium and vanadium, the titanium component amounting to approximately 5% to 95% relative to the vanadium component.

21. The X-ray tube of claim 16, wherein the getter comprises approximately 60% to 90% titanium as well as 40% to 10% zirconium and vanadium, the zirconium component amounting to approximately 5% to 95% relative to the vanadium component.
